(19) United States
(12) Patent Application Publication
(10) Pub. No.: US 2010/0299269 A1
(43) Pub. Date: Nov. 25, 2010

(54) METHOD OF SOLICITING AN AGGREGATE PURCHASE

(76) Inventor: Sean Martin, Malibu, CA (US)

Correspondence Address: ATTN: Eric L. Tanezaki;STETINA BRUNDA GARRED & BRUCKER, Suite 250, 75 Enterprise, Aliso Viejo, CA, 92656, US

(21) Appl. No.: 12/469,536

(22) Filed: May 20, 2009

(51) Int. Cl. G06Q 30/00

(52) U.S. Cl. 705/80

(57) ABSTRACT

There is provided a method of soliciting an aggregate purchase of goods/services from a plurality of prospective buyers. The method includes presenting to the plurality of prospective buyers an offer for purchase of multiple units of goods/services. The method includes presenting to the plurality of prospective buyers purchase commitment levels regarding the offer. At least one of the levels is a committed level corresponding to the prospective buyer agreeing to purchase a specific number of units related to the offer. The method includes receiving from the prospective buyers purchase commitment level indications with respect to the purchase commitment levels. The method includes presenting to the plurality of prospective buyers information derived from the purchase commitment level indications of prospective buyers for at least two of the purchase commitment levels. The information includes an indication of aggregate number of units which correspond to purchase commitment level indications of a committed level.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

Electronic Commerce, commonly known as e-commerce or eCommerce, involves the buying and selling of products or services over electronic systems such as the Internet and other computer networks. The amount of trade conducted electronically has grown extraordinarily with widespread Internet usage. A wide variety of commerce is conducted in this way. Goods and services may take the form of traditional physical items and services but also include virtual items such as access or subscriptions to data or premium content on a website.

The buying and selling of goods and services has resulted in a multitude of pricing schemes which are used to determine the final prices at which such goods or services are sold. Such schemes typically include some form of readily apparent incentive for both or either of the buyer and/or seller to act on an offer for purchase of goods or services. Some schemes may be based upon discount quantity pricing, various forms of auctions and reverse auctions, exclusive arrangements or “pre-sales” and combinations and hybrids of such pricing schemes.

A particular type of pricing scheme involves aggregate or joint purchasing power of a plurality of buyers. In such a case, it is contemplated that a seller is willing to provide lower pricing for bulk or volume sales. Typically only large companies have the wherewithal or need to make such transactions. However, a concerted effort on the part of many individuals or buying officers may result in an aggregation of buyers with the common goal of purchasing a common product or service type at reduced pricing.

In addition, given the open nature of the Internet to facilitate the flow and access to information to buyers and sellers, there are a myriad of opportunities to provide efficiencies in the marketplace. Depending upon the perspective of a given buyer or seller, efficiency may be according to various metrics, such as volume of units sold, timeframe or cycle of finalizing sales, quality of goods/services, and pricing or profit margin for examples. In addition to product cost reduction, a buyer participant in an aggregate purchase may realize other benefits related to increased planning for delivery of orders and distribution cost reduction. A seller may additionally benefit from lowered costs associated with manufacture, fulfillment, and warehousing by having fewer and larger orders.

In view of the foregoing, there is a need in the art of an improved method for soliciting aggregate purchases of goods/services in comparison to the prior art.

### BRIEF SUMMARY

There is provided a method of soliciting an aggregate purchase of goods/services from a plurality of prospective buyers. The method includes presenting, via a network computer, to the plurality of prospective buyers an offer for purchase of multiple units of goods/services. The offer includes a total number of units. The method further includes presenting, via a network computer, to the plurality of prospective buyers purchase commitment levels regarding the offer. At least one of the levels is a committed level corresponding to the prospective buyer agreeing to purchase a specific number of units related to the offer. The method further includes receiving, via a network computer, from the prospective buyers purchase commitment level indications with respect to the purchase commitment levels. The method further includes presenting, via a network computer, to the plurality of prospective buyers information derived from the purchase commitment level indications of prospective buyers for at least two of the purchase commitment levels. The information includes an indication of aggregate number of units which correspond to purchase commitment level indications of a committed level.

According to various embodiments, the step of receiving purchase commitment level indications includes: receiving various degrees of information based upon an indication of a specific commitment level. Payment information may be collected from prospective buyers indicating a committed level. The payment information may include credit card information. Contact information may be collected from prospective buyers. The contact information may be collected based upon specific commitment level indications. The step of presenting information derived from the purchase commitment level indications may include presenting different degrees of information based upon an indication of a specific commitment level. The step of presenting information derived from the purchase commitment level indications may include presenting an aggregate number of prospective buyers correlated to a specific commitment level. The step of presenting information derived from the purchase commitment level indications may include presenting an aggregate number of prospective buyers correlated to each specific commitment level. The method may further include revising the offer based upon the purchase commitment level information. The method may further include presenting, via a computer, to the prospective buyers the revised offer. The offer may include pricing information, and the revised offer may include revising the pricing information to reflect reduced pricing. The offer may include end of offer information, and the revised offer may include revising the end of offer information. The information may include an indication of aggregate number of units which correspond to purchase commitment level indications of a committed level is the number of units which correspond to purchase commitment level indications of a committed level. The steps of presenting to the prospective buyers via a computer network may include via a mobile computing device.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 depicts a symbolic exemplary networked enterprise server system and network connected computers for implementing methodologies of soliciting an aggregate purchase of goods/services from a plurality of prospective buyers in accordance with various embodiments of the present invention; and

FIG. 2 depicts a flow diagram of a methodology in accordance with an aspect of the present invention.

### DETAILED DESCRIPTION

The detailed description set forth below in connection with the appended drawings is intended as a description of the presently preferred embodiment of the invention, and is not intended to represent the only form in which the present invention may be constructed or utilized. Reference throughout the detailed description to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this detailed description are not necessarily all referring to the same embodiment. The following description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments. In the following description, numerous specific details are shown to provide a thorough understanding of embodiments of the invention. One skilled in the relevant art will recognize, however, that the invention may be practiced without one or more of the specific details, or with other methods, components, materials, etc. In other instances, well-known structures, materials, or operations are not shown or described to avoid obscuring aspects of the invention. It is further understood that the use of relational terms such as first and second, and the like are used solely to distinguish one from another entity without necessarily requiring or implying any actual such relationship or order between such entities.

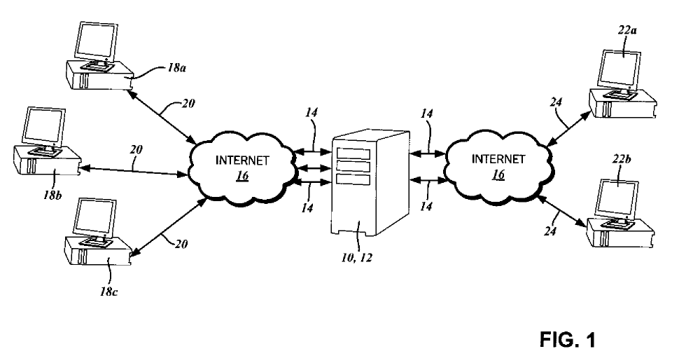

Referring now to FIG. 1, according to an aspect of the invention, there is depicted a symbolic exemplary networked enterprise server system 10 for implementing methodologies of soliciting an aggregate purchase of goods/services from a plurality of prospective buyers in accordance with various embodiments of the present invention. The networked enterprise server system 10 includes network application resources 12. The networked enterprise server system 10 includes various hardware and software components to facilitate the hosting of the network application resources 12 and network connectivity. The hardware and software may be physically collocated or distributed. In an embodiment, the enterprise server system 10 is also connected to the Internet 16 via network connections 14. Those having ordinary skill in the art will readily appreciate the numerous possible variations with regard to the hardware and software that comprise the enterprise server system 10 and the network application resources 12, as well as the network connections 14.

The network application resources 12 are referenced expansively and understood to include any kind of data processing functionality such as buyer account management, seller account management, billing, payment processing, content management, e-mail, file sharing, customer relationship management, scheduling, business management, and so forth. Furthermore, beyond the aforementioned enterprise-level applications, the network application resources 12 are also understood to include services that may be accessible by the public such as electronic banking and e-commerce. In this regard, one embodiment of the present invention envisions the network application resources 12 including a web server, application servers, and data stores.

A plurality of buyer computer systems 18 (individually denoted 18a-c in the symbolic diagram of FIG. 1) may interface with the enterprise server system 10 via the Internet 16. In this context, at a basic conceptual level, the role of the buyer computer system 18 as a requester of data or services, while the role of the enterprise server system 10 to provide such data or services. Each buyer computer system 18, which, by way of example only and not of limitation, may be a conventional desktop computer having a central processing unit, memory, and input and output devices connected thereto such as keyboards, mice, and display units. In the embodiment illustrated, each buyer computer system 18 is connected to a wide area network such as the Internet 16 via network connections 20 to access a variety of available services. Those having ordinary skill in the art will readily appreciate the numerous possible variations with regard to the hardware devices that comprise a given buyer computer system 18, as well as the associated network connection 16. In this regard, a given buyer computer system 18 may take the form of a mobile device.

Though each buyer computer system 18 is capable of communicating with any other system on the Internet 16, the example shown in FIG. 1 depicts links to the enterprise server system 10 generally. In the context of the methodologies of the present invention, the buyer computer system 18 accesses the enterprise server system 10 to utilize network application resources 12. Each buyer computer system 18 is understood to have software instructions loaded thereon that, when executed, perform various functions to interface with the enterprise server system 10. By way of example only and not of limitation, each buyer computer system 18 may have a web browsing application such as Internet Explorer from Microsoft Corporation of Redmond, Wash., or Firefox from the Mozilla Foundation that communicate with the enterprise server system 10, and the network application resources 12 in particular. The web browsing application may have various secure data link features such as cryptographic certificate stores, encryption/decryption engines, digital signature validation engines, applets, downloadable portions of software code and the like as may be well known to one of ordinary skill in the art. As such various functions may be accomplished on either client side or server side or of any combination. It is noted that a web browser is not required and other software implementations may connect with the sellers and the buyers without use of the Internet 16.

It is contemplated that associated with each buyer computer system 18 is a buyer or prospective buyer. The prospective buyer may be an individual or business entity. Due to the multi-user nature of the network application resources 12, the network application resources 12 facilitate each prospective buyer to be provided with a separate account to access the same. Such an account represents the aggregate collection of data associated with a prospective buyer including an account name. A collection of data for a particular user in the aggregate is referred to herein as buyer information, and is uniquely referenced by an account name. Furthermore, as a first layer of security to prevent unauthorized use, each account is protected with, for example, a password that is intended to be known only by the specific prospective buyer at his/her discretion. In this regard, it is understood that a given buyer computer system 18 may be utilized by multiple individual prospective buyers each having his/her own account (such as in the case of a household computer). In addition to the foregoing account name and password information, the buyer information may include other data such as mailing or delivery address, billing address, telephone numbers, e-mail addresses, organizational positions, company information and the like.

One or more seller computer systems 22 (individually denoted 22a-b in the symbolic diagram of FIG. 1) may interface with the enterprise server system 10 via the Internet 16. In this context, at a basic conceptual level, the role of the seller computer system 22 as a requester of data or services, while the role of the enterprise server system 10 to provide such data or services. Furthermore, at a conceptual level, the enterprise server system 10 facilitates business transactions between buyers and sellers.

Each seller computer system 22, which, by way of example only and not of limitation, may be a conventional desktop computer having a central processing unit, memory, and input and output devices connected thereto such as keyboards, mice, and display units. In the embodiment illustrated, each seller computer system 22 is connected to a wide area network such as the Internet 16 via network connections 24 to access a variety of available services. Those having ordinary skill in the art will readily appreciate the numerous possible variations with regard to the hardware devices that comprise a given seller computer system 22, as well as the associated network connection 24.

Though each seller computer system 22 is capable of communicating with any other system on the Internet 16, the example shown in FIG. 1 depicts links to the enterprise server system 10 generally. In the context of the methodologies of the present invention, the seller computer system 22 accesses the enterprise server system 10 to utilize network application resources 12. Each seller computer system 22 is understood to have software instructions loaded thereon that, when executed, perform various functions to interface with the enterprise server system 10. By way of example only and not of limitation, each seller computer system 22 has a web browsing application such as Internet Explorer from Microsoft Corporation of Redmond, Wash., or Firefox from the Mozilla Foundation that communicate with the enterprise server system 10, and the network application resources 12 in particular. The web browsing application may have various secure data link features such as cryptographic certificate stores, encryption/decryption engines, digital signature validation engines, applets, downloadable portions of software code and the like as may be well known to one of ordinary skill in the art. As such various functions may be accomplished on either client side or server side or of any combination.

It is contemplated that associated with each seller computer system 22 is a seller. The seller may be an individual or business entity. Due to the multi-user nature of the network application resources 12, the network application resources 12 facilitate each seller is to be provided a separate account to access the same. Such an account represents the aggregate collection of data associated with the seller including an account name. A collection of data for a particular seller in the aggregate is referred to herein as buyer information, and is uniquely referenced by an account name. Furthermore, as a first layer of security to prevent unauthorized use, each account is protected with, for example, a password that is intended to be known only by the specific seller at his/her discretion. In this regard, it is understood that a given seller computer system 22 may be utilized by multiple individual prospective buyers each having his/her own account. In addition to the foregoing account name and password information, the seller information may include other data pertaining to the seller and any of its goods/services.

The enterprise computer system 10 is contemplated to be operated, utilized or otherwise controlled by an entity different than the buyers and sellers. Such an operator may be generally referred to as a host. As such the host may typically facilitate business transactions between a variety of buyers and sellers. However, it is contemplated that a seller may itself be the operator or host of the enterprise computer system 10. As such, the enterprise computer system 10 is configured to facilitate an online marketplace in which buyers and sellers may transact business with each other.

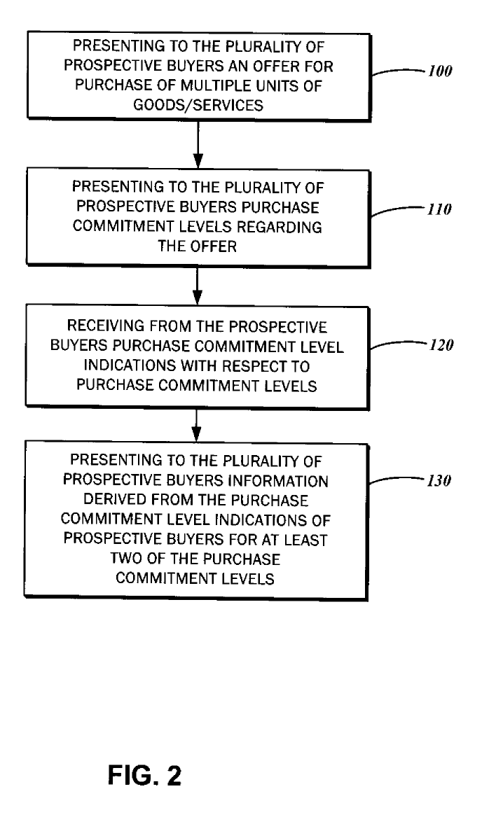

Referring additionally to the flow diagram of FIG. 2, in accordance with an aspect of the present invention, there is provided a method of soliciting an aggregate purchase of goods/services from a plurality of prospective buyers. The method includes the step 100 of presenting, via a network computer, to the plurality of prospective buyers an offer for purchase of multiple units of goods/services. The offer includes a total number of units. The method further includes the step 110 of presenting, via a network computer, to the plurality of prospective buyers purchase commitment levels regarding the offer, and at least one of the levels being a committed level corresponding to the prospective buyer agreeing to purchase a specific number of units related to the offer. The method further includes the step 120 of receiving, via a network computer, from the prospective buyers purchase commitment level indications with respect to the purchase commitment levels. The method further includes the step 130 of presenting, via a network computer, to the plurality of prospective buyers information derived from the purchase commitment level indications of prospective buyers for at least two of the purchase commitment levels. The information includes an indication of aggregate number of units which correspond to purchase commitment level indications of a committed level.

As used herein the term “goods/services” refers broadly to any goods and/or services in which a transaction may be effectuated. Such a transaction need not be monetary based and may involve other forms of payment or commitment, such as bartering of goods and/or services or other obligation. Further as used herein the term “prospective buyer” and “buyer” is used interchangeably, and generally refers to an entity that is responsive to an offer by a seller.

The forgoing method may be implemented through the use of the exemplary computing environment described above. In this regard, the enterprise server system 10 and the network application resources 12 may be used to interface with the prospective buyers through their respective buyer computer systems 18. As mentioned above, the method includes the step 100 of presenting, via a network computer, to the plurality of prospective buyers an offer for purchase of multiple units of goods/services. The offer includes a total number of units. As such, the network computer may be the enterprise server system 10. As a precursor activity, a seller may initially setup an account using the network application resources 12 to provide details concerning the offer.

In an embodiment, the prospective buyers are presented with the offer where the enterprise server system 10 is a hosted website accessible through the Internet 16. Prospective buyers may log onto their respective accounts and view an offer that is being presented at the host website. For example, the offer may be for 1000 units of X brand memory chips priced at $100 per unit. Various prospective buyers may indicate their respective purchase commitment levels.

As further mentioned above the method includes the step 110 of presenting, via a network computer, to the plurality of prospective buyers purchase commitment levels regarding the offer. In addition to “committed”, other purchase commitment levels may include “curious” and “interested” for examples. Thus, the prospective buyers would be provided with a choice to indicate if they would like to commit as any of the presented commitment levels.

As further mentioned above the method includes the step 120 of receiving, via a network computer, from the prospective buyers purchase commitment level indications with respect to the purchase commitment levels. Thus, in keeping with the above example, one prospective buyer may input to the website that their purchase commitment level indication as being “committed” to purchase 100 units. Another prospective buyer may input to the website that they are “committed” to purchase 200 units. And yet another prospective buyer may input to the website that they are “committed” to purchase 500 units. This represents an aggregate of 800 units of the total 1000 that have been indicated that 3 prospective buyers are committed to purchase. In addition, fifteen prospective buyers may input to the website that they are “interested”, and ten prospective buyers may input to the website that they are just “curious”.

As further mentioned above the method includes the step 130 of presenting, via a network computer, to the plurality of prospective buyers information derived from the purchase commitment level indications of prospective buyers for at least two of the purchase commitment levels. The information includes an indication of aggregate number of units which correspond to purchase commitment level indications of a committed level. Continuing with the example, the prospective buyers would be presented at the website the purchase commitment level indications. This could include that 3 prospective buyers are “committed” to purchase 800 of the 1000 units of the offer; 15 prospective buyers are “interested”; and 10 prospective buyers are “curious”.

It is contemplated that this degree of feedback or information that prospective buyers may be provided with allows the prospective buyers to more strategically go about the business of responding to offers. Significantly, the prospective buyers are provided with information derived from the purchase commitment level indications of prospective buyers for at least two of the purchase commitment levels. Thus, in the above example, the prospective buyers are presented with an additional dimension of information beyond merely knowing how many units have been committed. In this regard, just the fact that there are fifteen “interested” prospective buyers may indicate to a given one of the buyers that if they really want to be in on this offer they had better change their commitment level to “committed” for the desired number of unit of the 200 retaining. In another example, it would be a very factual situation if there were no “interested” or “curious” prospective buyers. This situation may result in at least one of the three committed prospective buyers to commit to purchase additional units in order to obtain the desired pricing of the offer.

The various steps 100, 110 and 130 of “presenting, via a network computer” and step 120 of “receiving via a network computer” may be effectuated by a variety of ways. For example, the presenting may be displayed to a seller or buyer accessing a hosted website. In addition, such presentation may occur through the use of electronic messages (such as email or SMS messaging, or communications sent via intermediate web facilities or website (such as “Twitter”). According, as used herein the term “via a network computer” refers to ability of a network computer to emanate electronic signals representative of the message or information sought to be transmitted (such as offer information).

According to various embodiments, the step 120 of receiving purchase commitment level indications includes receiving various degrees of information based upon an indication of a specific commitment level. For example, payment information may be collected from prospective buyers indicating a committed level. Such payment information may include credit card information or banking information. Other collected information may be just contact information. For example, at a “curious” commitment level indication, the system may require the prospective buyer to input such contact information.

In “exchange”, the system may provide with the prospective buyer with various degrees of information concerning the status of the offer. In this regard, the step 130 of presenting information derived from the purchase commitment level indications may include presenting different degrees of information based upon an indication of a specific commitment level. The step 130 of presenting information derived from the purchase commitment level indications may include presenting an aggregate number of prospective buyers correlated to a specific commitment level. Moreover, the step 130 of presenting information derived from the purchase commitment level indications includes presenting an aggregate number of prospective buyers correlated to each specific commitment level.

In addition, the method may further include the step of revising the offer based upon the purchase commitment level information. In this regard, the method would include presenting, via a computer, to the prospective buyers the revised offer. The offer may include pricing information, and the revised offer may include revising the pricing information to reflect reduced pricing. The offer may include end of offer information, and the revised offer may include revising the end of offer information. For example, this may be a specific date and time at which the offer is set to expire. Thus, where all of the units of a given offer are not committed within a certain period prior to the current end of the offer, the seller may strategically revise the offer to extend the end of offer date and time. The offer information may include an indication of aggregate number of units which correspond to purchase commitment level indications of a committed level is the number of units which correspond to purchase commitment level indications of a committed level. For example, this may include an indication that there have been 800 of 1000 units that are committed. However, this same information may be used to indicate that there are only 200 units remaining and are still uncommitted.

The seller may also choose to revise the offer in terms of total number of units, such as a downward adjustment. In the example above, the seller may adjust the offer to indicate that only 900 units are necessary to complete the transaction, thereby presenting this new information to the currently-committed buyers and/or prospective buyers as appropriate. The seller may hope that such a change in the offer may increase the likelihood of buyers committing to the now remaining 100 units.

In addition the buyers receiving feedback from the seller in connection with a given offer, the sellers and/or host may request feedback from the buyers. This may be during while an offer is outstanding or even after the offer is expired or transaction complete. For example, a prospective buyer decision to not commit may be prompted to provide information as to why this level was selected; such as the price being too high, or the end of offer date being to far into the future.

What is claimed is:

1. A method of soliciting an aggregate purchase of goods/services from a plurality of prospective buyers, the method comprising the steps of:
presenting, via a network computer, to the plurality of prospective buyers an offer for purchase of multiple units of goods/services, the offer including a total number of units;
presenting, via a network computer, to the plurality of prospective buyers purchase commitment levels regarding the offer, at least one of the levels being a committed level corresponding to the prospective buyer agreeing to purchase a specific number of units related to the offer;
receiving, via a network computer, from the prospective buyers purchase commitment level indications with respect to the purchase commitment levels; and
presenting, via a network computer, to the plurality of prospective buyers information derived from the purchase commitment level indications of prospective buyers for at least two of the purchase commitment levels, the information including an indication of aggregate number of units which correspond to purchase commitment level indications of a committed level.

2. The method of claim 1 wherein the step of receiving purchase commitment level indications includes: receiving various degrees of information based upon an indication of a specific commitment level.

3. The method of claim 1 wherein payment information is collected from prospective buyers indicating a committed level.

4. The method of claim 3 wherein the payment information includes credit card information.

5. The method of claim 1 wherein contact information is collected from prospective buyers.

6. The method of claim 5 wherein the contact information is collected based upon specific commitment level indications.

7. The method of claim 1 wherein the step of presenting information derived from the purchase commitment level indications includes presenting different degrees of information based upon an indication of a specific commitment level.

8. The method of claim 1 wherein the step of presenting information derived from the purchase commitment level indications includes presenting an aggregate number of prospective buyers correlated to a specific commitment level.

9. The method of claim 8 wherein the step of presenting information derived from the purchase commitment level indications includes presenting an aggregate number of prospective buyers correlated to each specific commitment level.

10. The method of claim 1 further includes the step of:
revising the offer based upon the purchase commitment level information.

11. The method of claim 10 further includes the step of:
presenting, via a computer, to the prospective buyers the revised offer.

12. The method of claim 10 wherein the offer includes pricing information, the revised offer includes revising the pricing information to reflect reduced pricing.

13. The method of claim 10 wherein the offer includes end of offer information, the revised offer includes revising the end of offer information.

14. The method of claim 1 wherein the offer includes end of offer information.

15. The method of claim 1 wherein the offer information includes an indication of aggregate number of units which correspond to purchase commitment level indications of a committed level is the number of units which correspond to purchase commitment level indications of a committed level.

16. The method of claim 1 wherein the steps of presenting to the prospective buyers via a computer network includes via a mobile computing device. <xx>The method of claim 1 wherein survey information is collected from the prospective buyers. The method of Claim <xx>wherein the survey information is collected based upon specific commitment level indications.
